(19) United States
(12) Patent Application Publication
(10) Pub. No.: US 2024/0147418 A1
(43) Pub. Date: May 2, 2024

(54) METHOD FOR SENDING PAGING EARLY INDICATION, METHOD FOR RECEIVING PAGING EARLY INDICATION AND BASE STATION DEVICE

(71) Applicant: BEIJING XIAOMI MOBILE SOFTWARE CO., LTD., Beijing (CN)

(72) Inventor: Ting FU, Beijing (CN)

(21) Appl. No.: 18/274,956

(22) PCT Filed: Jan. 29, 2021
(86) PCT No.: PCT/CN2021/074432

§ 371 Date: Jul. 28, 2023

(51) Int. Cl. H04W 68/02; H04W 72/0446; H04W 72/0453; H04W 72/232

(52) U.S. Cl. CPC H04W 68/02; H04W 72/0446; H04W 72/0453; H04W 72/232

(57) ABSTRACT

In a method for sending a paging early indication, a network side device determines a target paging occasion based on a first target moment. The first target moment is before a starting moment of a paging occasion of a user equipment group and is separated from the starting moment by an offset duration. The network side device sends, on a time-frequency resource of the target paging occasion, a Paging Early Indications (PEI) corresponding to the user equipment group.

### CROSS-REFERENCE TO RELATED APPLICATION

This application is a national phase of International Application No. PCT/CN2021/074432, filed on Jan. 29, 2021, the content of which is hereby incorporated by reference in its entirety.

### TECHNICAL FIELD

The disclosure relates to the field of wireless communication technologies, in particular to a method for sending a paging early indication, a method for receiving a paging early indication and a base station device.

### BACKGROUND

When a User Equipment (UE) is in a Radio Resource Control-IDLE (RRC-IDLE) state or a Radio Resource Control-INACTIVE (RRC-INACTIVE), the UE monitors a paging message, and after receiving the paging message, the UE enters a Radio Resource Control-CONNECTED (RRC-CONNECTED) state to carry out normal communications.

The paging message is carried on a Physical Downlink Shared channel (PDSCH) and is scheduled by Downlink Control Information (DCI) scrambled with a Paging-Radio Network Temporary Identity (P-RNTI).

### SUMMARY

According to a first aspect of embodiments of the disclosure, a method for sending a Paging Early Indication (PEI), performed by a network side device, is provided. The method includes:
determining a target Paging Occasion (PO) based on a first target moment, in which the first target moment is before a starting moment of a PO of a UE group, and is separated from the starting moment by an offset duration; and
sending, on a time-frequency resource of the target PO, a PEI corresponding to the UE group.

According to a second aspect of embodiments of the disclosure, a method for receiving a Paging Early Indication (PEI), performed by a user equipment (UE), is provided. The method includes:
determining a target Paging Occasion (PO) based on a second target moment, in which the second target moment is before a starting moment of a PO of the UE and is separated from the starting moment by an offset duration; and
receiving, on a time-frequency resource of the target PO, a PEI corresponding to the UE.

According to a third aspect of embodiments of the disclosure, a base station equipment is provided. The base station equipment includes:
a processor; and
a memory for storing instructions executable by the processor; in which
the processor is configured to execute the executable instructions in the memory to perform steps of a method for sending a Paging Early Indication (PEI).

### BRIEF DESCRIPTION OF THE DRAWINGS

The drawings described here are used to provide a further understanding of embodiments of the disclosure, and constitute a part of the disclosure. The example embodiments of the disclosure and their descriptions are used to explain the embodiments of the disclosure, and do not constitute an undue limitation to the embodiments of the disclosure.

The accompanying drawings, which are incorporated in and constitute a part of this disclosure, illustrate embodiments consistent with the embodiments of the disclosure, and together with the description serve to explain the principles of the embodiments of the disclosure.

FIG. 1 is a flowchart illustrating a method for sending a Paging Early Indication (PEI) according to an example embodiment.

FIG. 2 is a flowchart illustrating a method for sending a PEI according to an example embodiment.

FIG. 3 is a schematic diagram of a method for sending a PEI according to an example embodiment.

FIG. 4 is a block diagram illustrating an apparatus for sending a PEI according to an example embodiment.

FIG. 5 is a block diagram illustrating an apparatus for sending a PEI according to an example embodiment.

FIG. 6 is a block diagram illustrating an apparatus for sending a PEI according to an example embodiment.

FIG. 7 is a schematic diagram illustrating a method for receiving a PEI according to an example embodiment.

FIG. 8 is a block diagram illustrating an apparatus for sending a PEI according to an example embodiment.

FIG. 9 is a block diagram illustrating an apparatus for receiving a PEI according to an example embodiment.

FIG. 10 is a block diagram illustrating a device for sending a PEI according to an example embodiment.

FIG. 11 is a block diagram illustrating a device for receiving a PEI according to an example embodiment.

### DETAILED DESCRIPTION

Embodiments of the disclosure are further described in combination with the accompanying drawings and specific implementations.

Reference will now be made in detail to various embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the disclosure. Instead, they are merely examples of apparatuses and methods consistent with aspects related to the disclosure as recited in the appended claims.

For a user equipment (UE), its corresponding Paging Occasion (PO) occurs periodically. Multiple UEs may use the time-frequency resource of a same PO, i.e., paging messages for the multiple UEs may appear in one PO.

The paging message is carried on a Physical Downlink Shared channel (PDSCH) and is scheduled by Downlink Control Information (DCI) scrambled with a Paging-Radio Network Temporary Identity (P-RNTI).

While monitoring the paging message, the UE monitors whether there is a DCI scrambled with the P-RNTI in the corresponding PO and determines whether a Short Messages Indicator information field contained in the DCI indicates that the DCI schedules the PDSCH containing the paging message.

If the UE has monitored that there is a DCI scrambled with the P-RNTI in the corresponding PO and the Short Messages Indicator information field contained in the DCI indicates that the DCI schedules the PDSCH containing the paging message, the UE receives the PDSCH and demodulates the PDSCH according to an indication of the DCI.

If the UE has not monitored that there is a DCI scrambled with the P-RNTI in the corresponding PO, the UE does not receive any PDSCH. If the UE has monitored that there is a DCI scrambled with the P-RNTI in the corresponding PO, but the Short Messages Indicator information field contained in the DCI does not indicate that the DCI schedules the PDSCH containing the paging messages, the UE does not receive any PDSCH.

In order to reduce energy consumption of the UE in an idle state, a base station can send a Paging Early Indication (PEI) for the UE. If the PEI indicates that the UE needs to monitor the paging message in its own PO, then the UE monitors the paging message in its own PO after receiving the PEI. If the PEI indicates that the UE does not need to monitor any paging message in its own PO, them the UE does not need to monitor any paging message in its own PO after receiving the PEI.

For sending a Downlink Control Information (DCI)-based Paging Early Indication (PEI) in a Paging Occasion (PO), determining the PO for sending the PEI according to an offset configured by a network side for a user equipment (UE) is a feasible solution.

Embodiments of the disclosure provide a method for sending a PEI. This method is performed by a network side device. For example, the network side device is a base station device.

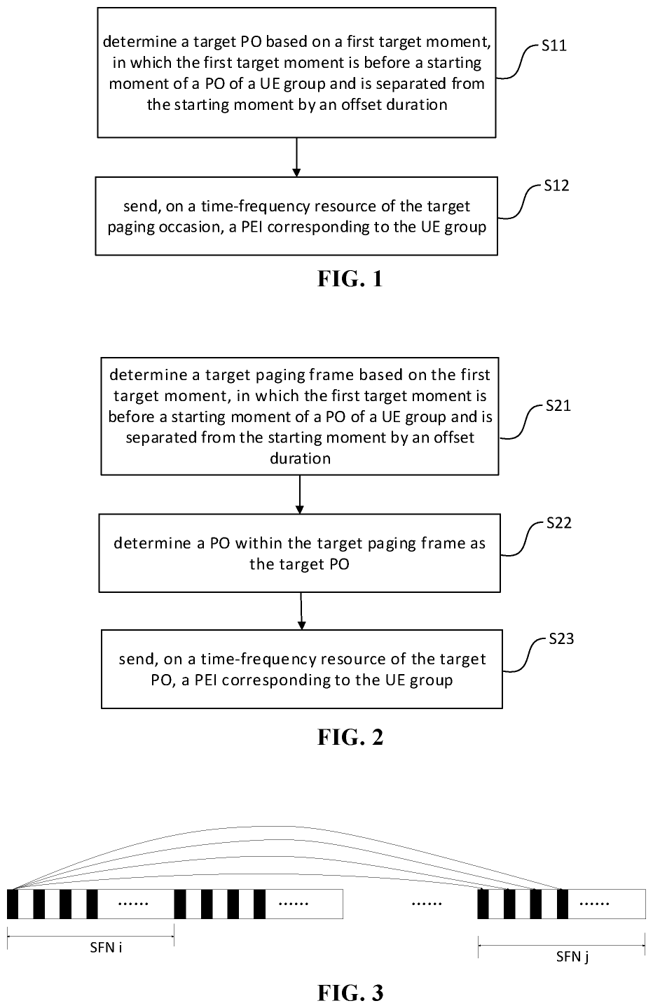

FIG. 1 is a flowchart illustrating a method for sending a PEI according to an example embodiment. As illustrated in FIG. 1, the method includes the following.

At step S11, a target PO is determined based on a first target moment, in which the first target moment is before a starting moment of a PO of a UE group and is separated from the starting moment by an offset duration.

The offset duration is an offset parameter of the first target moment that is defined by the base station or a protocol.

At step S12, a PEI corresponding to the UE group is sent on a time-frequency resource of the target PO.

In embodiments of the disclosure, the target PO is determined based on the offset duration that has already been configured, and the PEI corresponding to the UE group is sent on the time-frequency resource of the target PO, thereby providing a solution for determining the target PO.

Embodiments of the disclosure provide a method for sending a PEI performed by a network side device. The method includes: determining a target PO based on a first target moment, in which first target moment is before a starting moment of a PO of a UE group and is separated from the starting moment by an offset duration, and the target PO is before the first target moment; and sending the PEI corresponding to the UE group on a time-frequency resource of the target PO.

In embodiments of the disclosure, the determined target PO is before the first target moment, which can better ensure that there is enough Synchronization Signal Blocks (SSBs) for the UE to perform an accurate synchronization if there is a need to wake up and to demodulate the PDSCH carrying a paging message that need to be received subsequently, after demodulating the PEI.

Embodiments of the disclosure provide a method for sending a PEI performed by a network side device. The method includes: determining a target PO based on a first target moment, in which the first target moment is before a starting moment of a PO of a UE group and is separated from the starting moment by an offset duration, and the target PO is after the first target moment; and sending the PEI corresponding to the UE group on a time-frequency resource of the target PO.

In embodiments of the disclosure, the determined target PO is after the first target moment, which reduces a duration of light sleep of the UE between the demodulating of the PEI and the receiving of the paging message, thereby reducing the energy consumption of the UE in the light sleep state.

Embodiments of the disclosure provide a method for sending a PEI performed by a network side device. The method includes: determining a PO before the first target moment and closest to the first target moment as the target PO, in which the first target moment is before a starting moment of a PO of a UE group and is separated from the starting moment by an offset duration; and sending, on a time-frequency resource of the target PO, the PEI corresponding to the UE group.

Embodiments of the disclosure provide a method for sending a PEI performed by a network side device. The method includes: determining a PO after the first target moment and closest to the first target moment as the target PO, in which the first target moment is before a starting moment of a PO of a UE group and is separated from the starting moment by an offset duration; and sending, on a time-frequency resource of the target PO, the PEI corresponding to the UE group.

Embodiments of the disclosure provide a method for sending a PEI performed by a network side device. FIG. 2 is a flowchart illustrating a method for sending a PEI according to an example embodiment. As illustrated in FIG. 2, the method includes the following.

At step S21, a target paging frame is determined based on the first target moment. The first target moment is before a starting moment of a PO of a UE group and is separated from the starting moment by an offset duration.

At step S22, one PO within the target paging frame is determined as the target PO.

At step S23, the PEI corresponding to the UE group is sent on a time-frequency resource of the target PO.

In an implementation, a PEI indicates a paging message.

In an implementation, a PEI indicates both a paging message and a system short message.

In embodiments of the disclosure, the target paging frame is determined based on the offset duration that has been already configured, and the PEI corresponding to the UE group is sent on the time-frequency resource of the target PO, thereby providing a solution for determining the target PO.

Embodiments of the disclosure provide a method for sending a PEI performed by a network side device. The method includes: determining a target paging frame, in which a starting moment of the target paging frame is before the first target moment and closest to the first target moment, and the first target moment is before a starting moment of a PO of a UE group and is separated from the starting moment by an offset duration; determining one PO within the target paging frame as the target PO; and sending the PEI corresponding to the UE group on a time-frequency resource of the target PO.

Embodiments of the disclosure provide a method for sending a PEI performed by a network side device. The method includes: determining a target paging frame, in which an ending moment of the target paging frame is before the first target moment and closest to the first target moment, and the first target moment is before a starting moment of a PO of a UE group and is separated from the starting moment by an offset duration.

For example, the Paging Frame (PF) whose starting moment is before and closest to the target time among radio frames is determined as a System Frame Number (SFN) for transmitting the PEI.

The method further includes determining one PO within the target PF as the target PO; and sending the PEI corresponding to the UE group on a time-frequency resource of the target PO.

Embodiments of the disclosure provide a method for sending a PEI performed by a network side device. The method includes: determining a target PF, in which a starting moment of the target PF is after the first target moment and closest to the first target moment, and the first target moment is before a starting moment of a PO of a UE group and is separated from the starting moment by an offset duration.

For example, the PF whose starting time is after and closest to the target time among radio frames is determined as the SFN for transmitting the PEI.

The method further includes determining one PO within the target PF as the target PO; and sending the PEI corresponding to the UE group on a time-frequency resource of the target PO.

Embodiments of the disclosure provide a method for sending a PEI performed by a network side device. The method includes: determining a target PF, in which an ending moment of the target PF is before the first target moment and closest to the first target moment, and the first target moment is before a starting moment of a PO of a UE group and is separated from the starting moment by an offset duration.

For example, the PF whose ending time is before and closest to the target time among radio frames is determining as the SFN for transmitting the PEI.

The method further includes determining one PO within the target PF as the target PO; and sending the PEI corresponding to the UE group on a time-frequency resource of the target PO.

The method further includes determining any PO within the target PF as the target PO; and sending, on the time-frequency resource of the target PO, the PEI corresponding to the UE group.

Embodiments of the disclosure provide a method for sending a PEI performed by a network side device. The method includes: determining a target PF, in which an ending moment of the target PF is after the first target moment and closest to the first target moment, and the first target moment is before a starting moment of a PO of a UE group and is separated from the starting moment by an offset duration.

For example, the PF whose ending time is after and closest to the target time among radio frames is determined as the SFN for transmitting the PEI.

The method further includes determining one PO within the target PF as the target PO; and sending the PEI corresponding to the UE group on a time-frequency resource of the target PO.

Embodiments of the disclosure provide a method for sending a PEI performed by a network side device. The method includes: determining a target PF based on the first target moment, in which the first target moment is before a starting moment of a PO of a UE group and is separated from the starting moment by an offset duration; determining a set PO within the target PF as the target PO, in which the set PO is any PO within the target PF; and sending the PEI corresponding to the UE group on a time-frequency resource of the target PO.

In an implementation, determining the set PO within the target PF as the target PO includes: determining a fixed PO within the target PF as the target PO.

In an implementation, a first one of POs (or called first PO) within the target PF is determined as the target PO.

In an example, as illustrated in FIG. 3, the PEI of the UE group corresponding to a PO whose index is 0 within SFNj (i.e., the PF whose SFN is j) is transmitted on the time-frequency resource of the first PO (i.e., the PO whose index is 0) within SFNi (i.e., the PF whose SFN is i).

The PEI of the UE group corresponding to a PO whose index is 1 within SFNj (i.e., the PF whose SFN is j) is transmitted on the time-frequency resource of the first PO (i.e., the PO whose index is 0) within SFNi (i.e., the PF whose SFN is i).

The PEI of the UE group corresponding to a PO whose index is 2 within SFNj (i.e., the PF whose SFN is j) is transmitted on the time-frequency resource of the first PO (i.e., the PO whose index is 0) within SFNi (i.e., the PF whose SFN is i).

The PEI of the UE group corresponding to a PO whose index is 3 within SFNj (i.e., the PF whose SFN is j) is transmitted on the time-frequency resource of the first PO (i.e., the PO whose index is 0) within SFNi (i.e., the PF whose SFN is i).

Therefore, the PEIs of all UEs contained in 3 UE groups corresponding to 4 POs within SFNj (i.e., the PF whose SFN is j) are transmitted on the time-frequency resource of the first PO (i.e., the PO whose index is 0) within SFNi (i.e., the PF whose SFN is i).

In an implementation, a second one of POs (or called second PO) within the target PF is determined as the target PO.

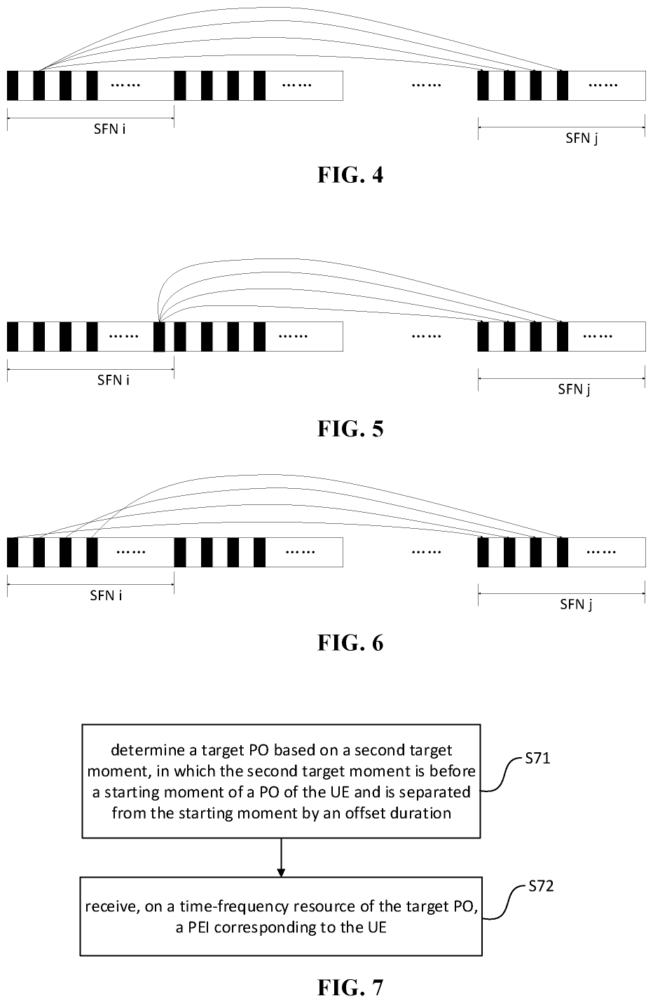

In an example, as illustrated in FIG. 4, the PEI of the UE group corresponding to a PO whose index is 0 within SFNj (i.e., the PF whose SFN is j) is transmitted on the time-frequency resource of the second PO (i.e., the PO whose index is 1) within SFNi (i.e., the PF whose SFN is i).

The PEI of the UE group corresponding to a PO whose index is 1 within SFNj (i.e., the PF whose SFN is j) is transmitted on the time-frequency resource of the second PO (i.e., the PO whose index is 1) within SFNi (i.e., the PF whose SFN is i).

The PEI of the UE group corresponding to a PO whose index is 2 within SFNj (i.e., the PF whose SFN is j) is transmitted on the time-frequency resource of the second PO (i.e., the PO whose index is 1) within SFNi (i.e., the PF whose SFN is i).

The PEI of the UE group corresponding to a PO whose index is 3 within SFNj (i.e., the PF whose SFN is j) is transmitted on the time-frequency resource of the second PO (i.e., the PO whose index is 1) within SFNi (i.e., the PF whose SFN is i).

Therefore, the PEIs of all UEs contained in 4 UE groups corresponding to 4 POs within SFNj (i.e., the PF whose SFN is j) are transmitted on the time-frequency resource of the second PO (i.e., the PO whose index is 1) within SFNi (i.e., the PF whose SFN is i).

In an implementation, a last one of POs (or called last PO) within the target PF is determined as the target PO.

In an example, each SFN includes m POs. As illustrated in FIG. 5, the PEI of the UE group corresponding to a PO whose index is 0 within SFNj (i.e., the PF whose SFN is j) is transmitted on the time-frequency resource of the last PO (i.e., the PO whose index is (m−1)) within SFNi (i.e., the PF whose SFN is i).

The PEI of the UE group corresponding to a PO whose index is 1 within SFNj (i.e., the PF whose SFN is j) is transmitted on the time-frequency resource of the last PO (i.e., the PO whose index is (m−1)) within SFNi (i.e., the PF whose SFN is i).

The PEI of the UE group corresponding to a PO whose index is 2 within SFNj (i.e., the PF whose SFN is j) is transmitted on the time-frequency resource of the last PO (i.e., the PO whose index is (m−1)) within SFNi (i.e., the PF whose SFN is i).

The PEI of the UE group corresponding to a PO whose index is 3 within SFNj (i.e., the PF whose SFN is j) is transmitted on the time-frequency resource of the last PO (i.e., the PO whose index is (m−1)) within SFNi (i.e., the PF whose SFN is i).

Therefore, the PEIs of all UEs contained in 4 UE groups corresponding to 4 POs within SFNj (i.e., the PF whose SFN is j) are transmitted on the time-frequency resource of the last PO (i.e., the PO whose index is (m−1)) within SFNi (i.e., the PF whose SFN is i).

Embodiments of the disclosure provide a method for sending a PEI performed by a network side device. The method includes: determining a target PF based on the first target moment, in which the first target moment is before a starting moment of a PO of a UE group and is separated from the starting moment by an offset duration; determining one PO within the target PF as the target PO, in which an index of one PO within the target PF is identical to an index of the PO of the UE group; and sending the PEI corresponding to the UE group on a time-frequency resource of the target PO.

In an example, as illustrated in FIG. 6, the PEI of the UE group corresponding to a PO whose index is 0 within SFNj (i.e., the PF whose SFN is j) is transmitted on the time-frequency resource of the first PO (i.e., the PO whose index is 0) within SFNi (i.e., the PF whose SFN is i).

The PEI of the UE group corresponding to a PO whose index is 1 within SFNj (i.e., the PF whose SFN is j) is transmitted on the time-frequency resource of the second PO (i.e., the PO whose index is 1) within SFNi (i.e., the PF whose SFN is i).

The PEI of the UE group corresponding to a PO whose index is 2 within SFNj (i.e., the PF whose SFN is j) is transmitted on the time-frequency resource of the third PO (i.e., the PO whose index is 2) within SFNi (i.e., the PF whose SFN is i).

The PEI of the UE group corresponding to a PO whose index is 3 within SFNj (i.e., the PF whose SFN is j) is transmitted on the time-frequency resource of the fourth PO (i.e., the PO whose index is 3) within SFNi (i.e., the PF whose SFN is i).

Therefore, the PEI of all UEs contained in a UE group corresponding to a PO within SFNj (i.e., the PF whose SFN is j) is transmitted on the time-frequency resource of a PO having the same index as the PO within SFNj within SFNi (i.e., the PF whose SFN is i).

Embodiments of the disclosure provide a method for sending a PEI performed by a network side device. The method includes: determining a target PO based on a first target moment, in which the first target moment is before a starting moment of a PO of a UE group and is separated from the starting moment by an offset duration; and sending a paging DCI on a time-frequency resource of the target PO, in which the paging DCI includes a preset field, and the preset field contains the PEI corresponding to the UE group.

In an implementation, a PEI carried in the paging DCI in the PO whose index is m in the PF whose SFN is i is used to indicate whether there is a paging message for a UE corresponding to the PO whose index is n in the SFN j, in which m and n are integers for representing indexes.

If the PEI in the PO whose index is m in the PF whose SFN is i indicates that there is a paging message, the UE corresponding to the PO whose index is n in the PF whose SFN is j needs to blindly detect the paging DCI in the PO whose index is n in the PF whose SFN is j, and receives and demodulates the PDSCH (in which the paging message is included in the PDSCH) based on the indication of the paging DCI.

If the PEI in the PO whose index is m in the PF whose SFN is i indicates that there is no paging message, the UE corresponding to the PO whose index is n in the PF whose SFN is j does not need to blindly detect the paging DCI in the PO whose index is n in the PF whose SFN is j or receive and demodulate the PDSCH.

Embodiments of the disclosure provide a method for sending a PEI performed by a network side device. The method includes: determining a target PO based on a first target moment, in which the first target moment is before a starting moment of a PO of a UE group and is separated from the starting moment by an offset duration; and sending a paging DCI on a time-frequency resource of the target PO, in which the paging DCI includes N preset bits, and each of the N preset bits contains a PEI corresponding to a subgroup of the UE group, in which N is the number of subgroups in the UE group.

In this implementation, the preset bits in the paging DCI are used to indicate respective PEIs corresponding to the subgroups of the UE group under the same PO, and the granularity of the PEI corresponding to the UE group is divided into finer granularity by dividing the UE group into multiple subgroups, to indicate PEIs for smaller units of multiple UEs.

Embodiments of the disclosure provide a method for receiving a PEI performed by a UE.

FIG. 7 is a schematic diagram illustrating a method for receiving a PEI according to an example embodiment. As illustrated in FIG. 7, the method includes the following.

At step S71, a target PO is determined based on a second target moment. The second target moment is before a starting moment of a PO of the UE and is separated from the starting moment by an offset duration.

The offset duration is an offset parameter defined by the base station or a protocol.

At step S72, a PEI corresponding to the UE is received on a time-frequency resource of the target PO.

In embodiments of the disclosure, the network side device determines the target PO using the offset duration that has already been configured and sends the PEI corresponding to the UE group on the time-frequency resource of the target PO, such that the UE receives a PEI corresponding to the UE on the time-frequency resource of the corresponding target PO, thereby providing a solution for receiving the target PO.

Embodiments of the disclosure provide a method for receiving a PEI performed by a UE. The method includes: determining a target PO based on a second target moment, in which the second target moment is before a starting moment of a PO of the UE and is separated from the starting moment by an offset duration, in which the target PO is before the second target moment; and receiving a PEI corresponding to the UE on a time-frequency resource of the target PO.

In embodiments of the disclosure, the determined target PO is before the second target moment, which can better ensure that there is enough SSBs for the UE to perform the accurate synchronization if needing to wake up and to demodulate the PDSCH carrying the paging messages that need to be received subsequently, after demodulating the PEI.

Embodiments of the disclosure provide a method for receiving a PEI performed by a UE. The method includes: determining a target PO based on a second target moment, in which the second target moment is before a starting moment of a PO of the UE and is separated from the starting moment by an offset duration, and the target PO is after the second target moment; and receiving the PEI corresponding to the UE on a time-frequency resource of the target PO.

In embodiments of the disclosure, the determined target PO is after the second target moment, which reduces the duration of light sleep of the UE between the demodulating of the PEI and the receiving of the paging message, thereby reducing the energy consumption of the UE in the light sleep state.

Embodiments of the disclosure provide a method for receiving a PEI performed by a UE. The method includes: determining a PO that is before the second target moment and closest to the second target moment as the target PO, in which the second target moment is before a starting moment of a PO of the UE and is separated from the starting moment by an offset duration; and receiving a PEI corresponding to the UE on a time-frequency resource of the target PO.

Embodiments of the disclosure provide a method for receiving a PEI performed by a network side device. The method includes: determining a PO that is after the second target moment and closest to the second target moment as the target PO, in which the second target moment is before a starting moment of a PO of the UE and is separated from the starting moment by an offset duration; and receiving a PEI corresponding to the UE on a time-frequency resource of the target PO.

Embodiments of the disclosure provide a method for receiving a PEI performed by a UE. The method includes: determining a target PF based on the second target moment, in which the second target moment is before a starting moment of a PO of the UE and is separated from the starting moment by an offset duration; determining a PO within the target PF as the target PO; and receiving a PEI corresponding to the UE on a time-frequency resource of the target PO.

Embodiments of the disclosure provide a method for receiving a PEI performed by a UE. The method includes: determining a target PF, in which a starting moment of the target PF is before the second target moment and closest to the second target moment, and the second target moment is before a starting moment of a PO of the UE and is separated from the starting moment by an offset duration.

For example, the PF whose starting moment is before and closest to the target moment among radio frames is used as the SFN for transmitting the PEI.

The method further includes determining a PO within the target PF as the target PO; and receiving the PEI corresponding to the UE on a time-frequency resource of the target PO.

Embodiments of the disclosure provide a method for receiving a PEI performed by a UE. The method includes: determining a target PF, in which an ending moment of the target PF is before the second target moment and closest to the second target moment, and the second target moment is before a starting moment of a PO of the UE and is separated from the starting moment by an offset duration.

For example, the PF whose ending moment is before and closest to the target moment among radio frames is used as the SFN for transmitting the PEI.

The method further includes determining a PO within the target PF as the target PO; and receiving the PEI corresponding to the UE on a time-frequency resource of the target PO.

Embodiments of the disclosure provide a method for receiving a PEI performed by a UE. The method includes: determining a target PF, in which a starting moment of the target PF is after the second target moment and closest to the second target moment, and the second target moment is before a starting moment of a PO of the UE and is separated from the starting moment by an offset duration.

For example, the PF whose starting moment is after and closest to the target moment among radio frames is used as the SFN for transmitting the PEI.

The method further includes determining a PO within the target PF as the target PO; and receiving the PEI corresponding to the UE on a time-frequency resource of the target PO.

Embodiments of the disclosure provide a method for receiving a PEI performed by a UE. The method includes: determining a target PF, in which an ending moment of the target PF is after the second target moment and closest to the second target moment, and the second target moment is before a starting moment of a PO of the UE and is separated from the starting moment by an offset duration.

For example, the PF whose ending moment is after and closest to the target moment among radio frames is used as the SFN for transmitting the PEI.

The method further includes determining a PO within the target PF as the target PO; and receiving, on a time-frequency resource of the target PO, a PEI corresponding to the UE.

Embodiments of the disclosure provide a method for receiving a PEI performed by a UE. The method includes: determining a target PF based on the second target moment, in which the second target moment is before a starting moment of a PO of the UE and is separated from the starting moment by an offset duration; determining a preset PO within the target PF as the target PO; and receiving, on a time-frequency resource of the target PO, a PEI corresponding to the UE.

In an implementation, determining the preset PO within the target PF as the target PO includes: determining a fixed PO within the target PF as the target PO.

In an implementation, the first PO within the target PF is determined as the target PO.

In an implementation, the second PO within the target PF is determined as the target PO.

In an implementation, the last PO within the target PF is determined as the target PO.

Embodiments of the disclosure provide a method for receiving a PEI performed by a UE. The method includes: determining a target PF based on the second target moment, in which the second target moment is before a starting moment of a PO of the UE and is separated from the starting moment by an offset duration; determining a PO within the target PF as the target PO, in which an index of the PO within the target PF is identical to an index of the PO of the UE; and receiving, on a time-frequency resource of the target PO, a PEI corresponding to the UE.

Embodiments of the disclosure provide a method for receiving a PEI performed by a UE. The method includes: determining a target PO based on the second target moment, in which the second target moment is before a starting moment of a PO of the UE and is separated from the starting moment by an offset duration; and receiving a paging DCI on a time-frequency resource of the target PO, in which the paging DCI includes a preset field, and the preset field contains the PEI corresponding to the UE.

Embodiments of the disclosure provide a method for receiving a PEI performed by a UE. The method includes: determining a target PO based on the second target moment, in which the second target moment is before a starting moment of a PO of the UE and is separated from the starting moment by an offset duration; and receiving a paging DCI on a time-frequency resource of the target PO, in which the paging DCI includes preset bits corresponding to the UE, and the preset bits contain the PEI corresponding to the UE.

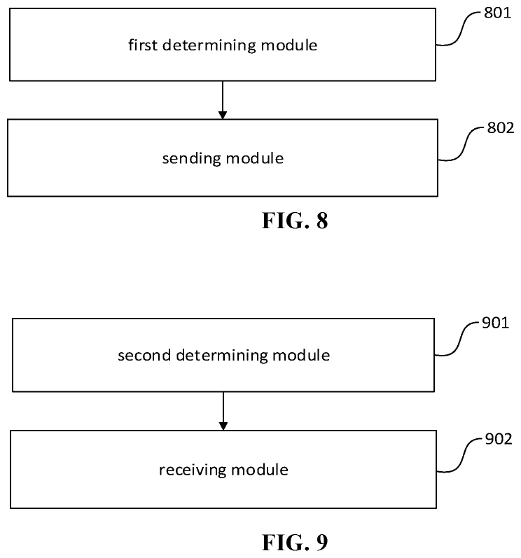

Embodiments of the disclosure provide an apparatus for sending a PEI, which is applied to a network side device. The apparatus is configured to perform the method for sending a PEI in any of the above embodiments. FIG. 8 is a block diagram illustrating an apparatus for sending a PEI according to an example embodiment. As illustrated in FIG. 8, the apparatus includes: a first determining module 801 and a sending module 802.

The first determining module 801 is configured to determine a target PO based on a first target moment, in which the first target moment is before a starting moment of a PO of a UE group and is separated from the starting moment by an offset duration.

The sending module 802 is configured to send, on a time-frequency resource of the target PO, a PEI corresponding to the UE group.

Embodiments of the disclosure provide an apparatus for sending a PEI, which is applied to a network side device. The apparatus further includes: a first determining module 801 and a sending module 802.

The first determining module 801 is configured to determine a PO that is before the first target moment and closest to the first target moment as the target PO, in which the first target moment is before a starting moment of a PO of a UE group and is separated from the starting moment by an offset duration.

The sending module 802 is configured to send, on a time-frequency resource of the target PO, a PEI corresponding to the UE group.

Embodiments of the disclosure provide an apparatus for sending a PEI, which is applied to a network side device. The apparatus further includes: a first determining module 801 and a sending module 802.

The first determining module 801 is configured to determine a PO that is after the first target moment and closest to the first target moment as a target PO, in which the first target moment is before a starting moment of a PO of a UE group and is separated from the starting moment by an offset duration.

The sending module 802 is configured to send, on a time-frequency resource of the target PO, a PEI corresponding to the UE group.

Embodiments of the disclosure provide an apparatus for sending a PEI, which is applied to a network side device. The apparatus further includes: a first determining module 801 and a sending module 802.

The first determining module 801 is configured to determine a target PF based on a first target moment, and determine a PO within the target PF as a target PO, in which the first target moment is before a starting moment of a PO of a UE group and is separated from the starting moment by an offset duration.

The sending module 802 is configured to send, on a time-frequency resource of the target PO, a PEI corresponding to the UE group.

Embodiments of the disclosure provide an apparatus for sending a PEI, which is applied to a network side device. The apparatus further includes: a first determining module 801 and a sending module 802.

The first determining module 801 is configured to determine a target PF based on a first target moment, and determine a PO within the target PF as a target PO, in which a starting moment of the target PF is before the first target moment and closest to the first target moment.

The first target moment is before a starting moment of a PO of a UE group and is separated from the starting moment by an offset duration.

The sending module 802 is configured to send, on a time-frequency resource of the target PO, a PEI corresponding to the UE group.

Embodiments of the disclosure provide an apparatus for sending a PEI, which is applied to a network side device. The apparatus further includes: a first determining module 801 and a sending module 802.

The first determining module 801 is configured to determine a target PF based on a first target moment, and determine a PO within the target PF as a target PO, in which an ending moment of the target PF is before the first target moment and closest to the first target moment.

The first target moment is before a starting moment of a PO of a UE group and is separated from the starting module by an offset duration.

The sending module 802 is configured to send, on a time-frequency resource of the target PO, a PEI corresponding to the UE group.

Embodiments of the disclosure provide an apparatus for sending a PEI, which is applied to a network side device. The apparatus further includes: a first determining module 801 and a sending module 802.

The first determining module 801 is configured to determine a target PF based on a first target moment, and determine a PO within the target PF as a target PO, in which a starting moment of the target PF is after the first target moment and closest to the first target moment.

The first target moment is before a starting moment of a PO of a UE group and is separated from the starting moment by an offset duration.

The sending module 802 is configured to send, on a time-frequency resource of the target PO, a PEI corresponding to the UE group.

Embodiments of the disclosure provide an apparatus for sending a PEI, which is applied to a network side device. The apparatus further includes: a first determining module 801 and a sending module 802.

The first determining module 801 is configured to determine a target PF based on a first target moment, and determine a PO within the target PF as a target PO, in which an ending moment of the target PF is after the first target moment and closest to the first target moment.

The first target moment is before a starting moment of a PO of a UE group and is separated from the starting moment by an offset duration.

The sending module 802 is configured to send, on a time-frequency resource of the target PO, a PEI corresponding to the UE group.

Embodiments of the disclosure provide an apparatus for sending a PEI, which is applied to a network side device. The apparatus further includes: a first determining module 801 and a sending module 802.

The first determining module 801 is configured to determine a target PF based on a first target moment, and determine a preset PO within the target PF as a target PO, in which the first target moment is before a starting moment of a PO of a UE group and is separated from the starting moment by an offset duration.

The sending module 802 is configured to send, on a time-frequency resource of the target PO, a PEI corresponding to the UE group.

Embodiments of the disclosure provide an apparatus for sending a PEI, which is applied to a network side device. The apparatus further includes: a first determining module 801 and a sending module 802.

The first determining module 801 is configured to determine a target PF based on a first target moment, and determine a PO within the target PF as a target PO, in which an index of the PO within the target PF is identical to an index of a PO of a UE group, and the first target moment is before a starting moment of the PO of the UE group and is separated from the starting moment by an offset duration.

The sending module 802 is configured to send, on a time-frequency resource of the target PO, a PEI corresponding to the UE group.

Embodiments of the disclosure provide an apparatus for sending a PEI, which is applied to a network side device. The apparatus further includes: a first determining module 801 and a sending module 802.

The first determining module 801 is configured to determine a target PO based on a first target moment, in which the first target moment is before a starting moment of a PO of a UE group and is separated from the starting moment by an offset duration.

The sending module 802, configured to send a paging DCI on a time-frequency resource of the target PO, in which the paging DCI includes a preset field, and the preset field contains the PEI corresponding to the UE group.

Embodiments of the disclosure provide an apparatus for sending a PEI, which is applied to a network side device. The apparatus further includes: a first determining module 801 and a sending module 802.

The first determining module 801 is configured to determine a target PO based on a first target moment, in which the first target moment is before a starting moment of a PO of a UE group and is separated from the starting moment by an offset duration.

The sending module 802 is configured to send a paging DCI on a time-frequency resource of the target PO, in which the paging DCI includes N preset bits, and each of the N preset bits contains a PEI corresponding to a subgroup of the UE group, in which N is the number of subgroups in the UE group.

Embodiments of the disclosure provide an apparatus for receiving a PEI, which is applied to a UE. The apparatus is configured to perform the method for receiving a PEI in any of the above embodiments. FIG. 9 is a block diagram illustrating an apparatus for receiving a PEI according to an example embodiment. As illustrated in FIG. 9, the apparatus includes: a second determining module 901 and a receiving module 902.

The second determining module 901 is configured to determine a target PO based on a second target moment, in which the second target moment is before a starting moment of a PO of the UE and is separated from the starting moment by an offset duration.

The receiving module 902 is configured to receive, on a time-frequency resource of the target PO, a PEI corresponding to the UE.

Embodiments of the disclosure provide an apparatus for receiving a PEI, which is applied to a UE. The apparatus further includes: a second determining module 901 and a receiving module 902.

The second determining module 901 is configured to determine a PO that is before a second target moment and closest to the second target moment as a target PO, in which the second target moment is before a starting moment of a PO of the UE is separated from the starting moment by an offset duration.

The receiving module 902 is configured to receive, on a time-frequency resource of the target PO, a PEI corresponding to the UE.

Embodiments of the disclosure provide an apparatus for receiving a PEI, which is applied to a UE. The apparatus further includes: a second determining module 901 and a receiving module 902.

The second determining module 901 is configured to determine a PO that is after a second target moment and closest to the second target moment as a target PO, in which the second target moment is before a starting moment of a PO of the UE and is separated from the starting moment by an offset duration.

The receiving module 902, configured to receive, on a time-frequency resource of the target PO, a PEI corresponding to the UE.

Embodiments of the disclosure provide an apparatus for receiving a PEI, which is applied to a UE. The apparatus further includes: a second determining module 901 and a receiving module 902.

The second determining module 901 is configured to determine a target PF based on a second target moment, and determine a PO within the target PF as a target PO, in which the second target moment is before a starting moment of a PO of the UE and is separated from the starting moment by an offset duration.

The receiving module 902 is configured to receive, on a time-frequency resource of the target PO, a PEI corresponding to the UE.

Embodiments of the disclosure provide an apparatus for receiving a PEI, which is applied to a UE. The apparatus further includes: a second determining module 901 and a receiving module 902.

The second determining module 901 is configured to determine a target PF based on a second target moment, and determine a PO within the target PF as a target PO, in which a starting moment of the target PF is before the second target moment and closest to the second target moment.

The second target moment is before a starting moment of a PO of the UE and is separated from the starting moment by an offset duration.

The receiving module 902 is configured to receive, on a time-frequency resource of the target PO, a PEI corresponding to the UE.

Embodiments of the disclosure provide an apparatus for receiving a PEI, which is applied to a UE. The apparatus further includes: a second determining module 901 and a receiving module 902.

The second determining module 901 is configured to determine a target PF based on a second target moment, and determine a PO within the target PF as a target PO, in which an ending moment of the target PF is before the second target moment and closest to the second target moment.

The second target moment is before a starting moment of a PO of the UE, and is separated from the starting moment by an offset duration.

The receiving module 902 is configured to receive, on a time-frequency resource of the target PO, a PEI corresponding to the UE.

Embodiments of the disclosure provide an apparatus for receiving a PEI, which is applied to a UE. The apparatus further includes: a second determining module 901 and a receiving module 902.

The second determining module 901 is configured to determine a target PF based on a second target moment, and determine a PO within the target PF as a target PO, in which a starting moment of the target PF is after the second target moment and closest to the second target moment.

The second target moment is before a starting moment of a PO of the UE and is separated from the starting moment by an offset duration.

The receiving module 902 is configured to receive, on a time-frequency resource of the target PO, a PEI corresponding to the UE.

Embodiments of the disclosure provide an apparatus for receiving a PEI, which is applied to a UE. The apparatus further includes: a second determining module 901 and a receiving module 902.

The second determining module 901 is configured to determine a target PF based on a second target moment, and determine a PO within the target PF as a target PO, in which an ending moment of the target PF is after the second target moment and closest to the second target moment.

The second target moment is before a starting moment of a PO of the UE, and is separated from the starting moment by an offset duration.

The receiving module 902 is configured to receive, on a time-frequency resource of the target PO, a PEI corresponding to the UE.

Embodiments of the disclosure provide an apparatus for receiving a PEI, which is applied to a UE. The apparatus further includes: a second determining module 901 and a receiving module 902.

The second determining module 901 is configured to determine a target PF based on a second target moment, and determine a preset PO within the target PF as a target PO, in which the second target moment is before a starting moment of a PO of the UE and is separated from the starting moment by an offset duration.

The receiving module 902 is configured to receive, on a time-frequency resource of the target PO, a PEI corresponding to the UE.

Embodiments of the disclosure provide an apparatus for receiving a PEI, which is applied to a UE. The apparatus further includes: a second determining module 901 and a receiving module 902.

The second determining module 901 is configured to determine a target PF based on a second target moment, and determine a PO within the target PF as a target PO, in which an index of the PO within the target PF is identical to an index of the PO of the UE, and the second target moment is before a starting moment of a PO of the UE and is separated from the starting moment by an offset duration.

The receiving module 902 is configured to receive, on a time-frequency resource of the target PO, a PEI corresponding to the UE.

Embodiments of the disclosure provide an apparatus for receiving a PEI, which is applied to a UE. The apparatus further includes: a second determining module 901 and a receiving module 902.

The second determining module 901 is configured to determine a target PO based on a second target moment, in which the second target moment is before a starting moment of a PO of the UE and is separated from the starting moment by an offset duration.

The receiving module 902 is configured to receive a paging DCI on the time-frequency resource of the target PO, in which the paging DCI includes a preset field, and the preset field contains the PEI corresponding to the UE.

Embodiments of the disclosure provide an apparatus for receiving a PEI, which is applied to a UE. The apparatus further includes: a second determining module 901 and a receiving module 902.

The second determining module 901 is configured to determine a target PO based on a second target moment, in which the second target moment is before a starting moment of a PO of the UE and is separated from the starting moment by an offset duration.

The receiving module 902 is configured to receive a paging DCI on the time-frequency resource of the target PO, in which the paging DCI includes preset bits corresponding to the UE, and the preset bits contain the PEI corresponding to the UE.

Embodiments of the disclosure provide a base station device. The base station device includes: a processor; and a memory for storing instructions executable by the processor.

The processor is configured to execute the executable instructions in the memory to implement the steps of the method for sending a PEI.

Embodiments of the disclosure provide a UE. The UE includes: a processor; and a memory for storing instructions executable by the processor.

The processor is configured to execute the executable instructions in the memory to implement the steps of the method for receiving a PEI.

Embodiments of the disclosure provide a non-transitory computer readable storage medium having executable instructions stored thereon. When the executable instructions are executed by a processor, the steps of the method for sending a PEI are implemented.

Embodiments of the disclosure provide a non-transitory computer readable storage medium having executable instructions stored thereon. When the executable instructions are executed by a processor, the steps of the method for receiving a PEI are implemented.

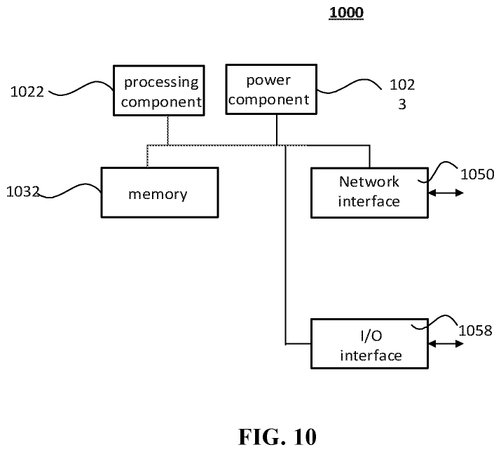

FIG. 10 is a block diagram illustrating a device 1000 for sending a PEI according to an example embodiment. For example, the device 1000 may be provided as a base station device. As illustrated in FIG. 10, the device 1000 includes a processing component 1022, which further includes one or more processors, and memory resources represented by a memory 1032 for storing instructions that can be executed by the processing component 1022, such as applications. The application programs stored in the memory 1032 may include one or more modules each corresponding to a set of instructions. In addition, the processing component 1022 is configured to execute the instructions to perform the method for sending a PEI described above.

The device 1000 may also include a power component 1026 configured to perform power management of the device 1000, a wired or wireless network interface 1050 configured to connect the device 1000 to a network, and an I/O interface 1058. The device 1000 may operate on an operating system stored in the memory 1032, such as Windows Server™, Mac OS X™, Unix™, Linux™, FreeBSD™, or the like.

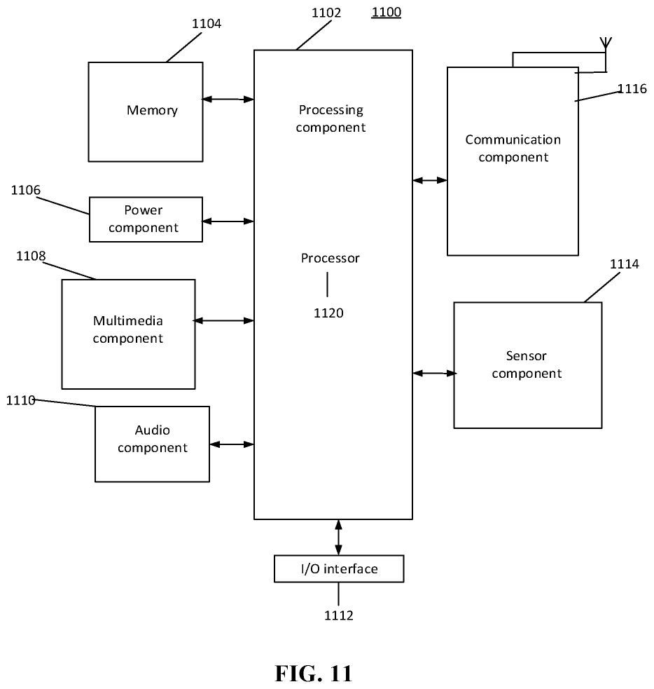

FIG. 11 is a block diagram illustrating a device 1100 for receiving a PEI according to an example embodiment. For example, the device 1100 may be a mobile phone, a computer, a digital broadcasting terminal, a message transceiver device, a game console, a tablet device, a medical device, a fitness device and a personal digital assistant.

As illustrated in FIG. 11, the device 1100 may include one or more of the following components: a processing component 1102, a memory 1104, a power component 1106, a multimedia component 1108, an audio component 1110, an input/output (I/O) interface 1112, a sensor component 1114, and a communication component 1116.

The processing component 1102 typically controls overall operations of the device 1100, such as the operations associated with display, telephone call, data communication, camera operation, and recording operation. The processing component 1102 may include one or more processors 1120 to perform all or part of the steps in the above described method. Moreover, the processing component 1102 may include one or more modules which facilitate the interaction between the processing component 1102 and other components. For example, the processing component 1102 may include a multimedia module to facilitate the interaction between the multimedia component 1108 and the processing component 1102.

The memory 1104 is configured to store various types of data to support the operation of the device 1100. Examples of such data include instructions for any applications or methods operated on the device 1100, contact data, phonebook data, messages, pictures, videos, etc. The memory 1104 may be implemented using any type of volatile or non-volatile memory devices, or a combination thereof, such as a Static Random-Access Memory (SRAM), an Electrically-Erasable Programmable Read Only Memory (EEPROM), an Erasable Programmable Read Only Memory (EPROM), a Programmable Read-Only Memory (PROM), a Read Only Memory (ROM), a magnetic memory, a flash memory, a magnetic or optical disk.

The power component 1106 provides power to various components of the device 1100. The power component 1106 may include a power management system, one or more power sources, and any other components associated with the generation, management, and distribution of power in the device 1100.

The multimedia component 1108 includes a screen providing an output interface between the device 1100 and the user. In some embodiments, the screen may include a Liquid Crystal Display (LCD) and a Touch Panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1108 includes a front-facing camera and/or a rear-facing camera. When the device 1100 is in an operating mode, such as a shooting mode or a video mode, the front-facing camera and/or the rear-facing camera can receive external multimedia data. Each front-facing camera and rear-facing camera may be a fixed optical lens system or has focal length and optical zoom capability.

The audio component 1110 is configured to output and/or input audio signals. For example, the audio component 1110 includes a microphone (MIC) configured to receive an external audio signal when the device 1100 is in an operation mode, such as a calling mode, a recording mode, and a voice recognition mode. The received audio signal may be further stored in the memory 1104 or transmitted via the communication component 1116. In some embodiments, the audio component 1110 further includes a speaker to output audio signals.

The I/O interface 1112 provides an interface between the processing component 1102 and peripheral interface modules, such as a keyboard, a click wheel, buttons, and the like. The buttons may include, but are not limited to, a home button, a volume button, a starting button, and a locking button.

The sensor component 1114 includes one or more sensors to provide status assessments of various aspects of the device 1100. For instance, the sensor component 1114 may detect an open/closed status of the device 1100, relative positioning of components, e.g., the display and the keypad, of the device 1100, a change in position of the device 1100 or a component of the device 1100, a presence or absence of user contact with the device 1100, an orientation or an acceleration/deceleration of the device 1100, and a change in temperature of the device 1100. The sensor component 314 may include a proximity sensor configured to detect the presence of nearby objects without any physical contact. The sensor component 1114 may also include a light sensor, such as a Complementary Metal Oxide Semiconductor (CMOS) or Charge-Coupled Device (CCD) image sensor, for use in imaging applications. In some embodiments, the sensor component 1114 may also include an accelerometer sensor, a gyroscope sensor, a magnetic sensor, a pressure sensor, or a temperature sensor.

The communication component 1116 is configured to facilitate communication, wired or wirelessly, between the device 1100 and other devices. The device 1100 can access a wireless network based on a communication standard, such as WiFi, 2G, or 3G, or a combination thereof. In an example embodiment, the communication component 1116 receives a broadcast signal or broadcast associated information from an external broadcast management system via a broadcast channel. In an example embodiment, the communication component 1116 further includes a Near Field Communication (NFC) module to facilitate short-range communication. For example, the NFC module may be implemented based on a RF Identification (RFID) technology, an Infrared Data Association (IrDA) technology, an Ultra-Wide Band (UWB) technology, a Blue Tooth (BT) technology, and other technologies.

In the example embodiment, the device 1100 may be implemented with one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, for performing the above described method.

In the example embodiments, there is also provided a non-transitory computer readable storage medium including instructions, such as the memory 1104, executable by the processor 1120 in the device 1100, for performing the above method. For example, the non-transitory computer-readable storage medium may be a ROM, a Random Access Memory (RAM), a CD-ROM, a magnetic tape, a floppy disc, and an optical data storage device.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the disclosure as come within known or customary practice in the art. It is intended that the specification and embodiments are considered as examples only, with a true scope and spirit of the disclosure being indicated by the following claims.

It will be appreciated that the disclosure is not limited to the exact construction that has been described above and illustrated in the accompanying drawings, and that various modifications and changes can be made without departing from the scope thereof. It is intended that the scope of the disclosure only be limited by the appended claims.

### INDUSTRIAL APPLICABILITY

The target PO is determined based on the offset duration that has already been configured, and the PEI corresponding to the UE group is sent on the time-frequency resource of the target PO, to provide a solution for determining the target PO.

In some examples, a method for sending a Paging Early Indication (PEI), performed by a base station device, includes: determining a target Paging Occasion (PO) based on a first target moment, in which the first target moment is before a starting moment of a PO of a UE group, and is separated from the starting moment by an offset duration; and sending, on a time-frequency resource of the target PO, a PEI corresponding to the UE group.

In some examples, determining the target PO based on the first target moment includes: determining a PO before the first target moment and closest to the first target moment as the target PO; or, determining a PO after the first target moment and closest to the first target moment as the target PO.

In some examples, determining the target PO based on the first target moment includes: determining a target paging frame based on the first target moment; and determining one PO within the target paging frame as the target PO.

In some examples, the target paging frame includes one of: a target paging frame whose starting moment is before the first target moment and closest to the first target moment; a target paging frame whose ending moment is before the first target moment and closest to the first target moment; a target paging frame whose starting moment is after the first target moment and closest to the first target moment; or a target paging frame whose ending moment is after the first target moment and closest to the first target moment.

In some examples, determining the PO within the target paging frame as the target PO includes: determining a set PO within the target paging frame as the target PO.

In some examples, determining one PO within the target paging frame as the target PO includes: determining one PO within the target paging frame as the target PO, in which an index of the PO within the target paging frame is identical to an index of the PO of the UE group.

In some examples, sending, on the time-frequency resource of the target PO, the PEI corresponding to the UE group includes: sending a paging DCI on the time-frequency resource of the target PO, in which the paging DCI includes a preset field, and the preset field contains the PEI corresponding to the UE group.

In some examples, sending, on the time-frequency resource of the target PO, the PEI corresponding to the UE group includes: sending a paging DCI on the time-frequency resource of the target PO, in which the paging DCI includes N preset bits, and each of the N preset bits contains a PEI corresponding to a subgroup of the UE group, in which N represents the number of subgroups in the UE group.

In some examples, a method for receiving a Paging Early Indication (PEI), performed by a user equipment (UE), includes: determining a target Paging Occasion (PO) based on a second target moment, in which the second target moment is before a starting moment of a PO of the UE and is separated from the starting moment by an offset duration; and receiving, on a time-frequency resource of the target PO, a PEI corresponding to the UE.

In some examples, determining the target PO based on the second target moment includes: determining a PO before the second target moment and closest to the second target moment as the target PO; or, determining a PO after the second target moment and closest to the second target moment as the target PO.

In some examples, determining the target PO based on the second target moment includes: determining a target paging frame based on the second target moment; and determining one PO within the target paging frame as the target PO.

In some examples, the target paging frame includes one of: a target paging frame whose starting moment is before the second target moment and closest to the second target moment; a target paging frame whose ending moment is before the second target moment and closest to the second target moment; a target paging frame whose starting moment is after the second target moment and closest to the second target moment; or a target paging frame whose ending moment is after the second target moment and closest to the second target moment.

In some examples, determining one PO within the target paging frame as the target PO includes: determining a set PO within the target paging frame as the target PO.

In some examples, determining one PO within the target paging frame as the target PO includes: determining one PO within the target paging frame as the target PO, in which an index of one PO within the target paging frame is identical to an index of the PO of the UE.

In some examples, receiving, on the time-frequency resource of the target PO, the PEI corresponding to the UE includes: receiving a paging DCI on the time-frequency resource of the target PO, in which the paging DCI includes a preset field, and the preset field contains the PEI corresponding to the UE.

In some examples, receiving, on the time-frequency resource of the target PO, the PEI corresponding to the UE includes: receiving a paging DCI on the time-frequency resource of the target PO, in which the paging DCI includes a preset bit corresponding to the UE, and the preset bit contains the PEI corresponding to the UE.

In some examples, an apparatus for sending a Paging Early Indication (PEI), applicable to a network side device, includes: a determining module, configured to determine a target Paging Occasion (PO) based on a first target moment, in which the first target moment is before a starting moment of a PO of a UE group and is separated from the starting moment by an offset duration; and a sending module, configured to send, on a time-frequency resource of the target PO, a PEI corresponding to the UE group.

In some examples, an apparatus for receiving a Paging Early Indication (PEI), applicable to a UE, includes: a second determining module, configured to determine a target Paging Occasion (PO) based on a second target moment, in which the second target moment is before a starting moment of a PO of the UE and has is separated from the starting moment by an offset duration; and a receiving module, configured to receive, on a time-frequency resource of the target PO, a PEI corresponding to the UE.

In some examples, a base station equipment includes: a processor; and a memory for storing instructions executable by the processor; in which the processor is configured to execute the executable instructions in the memory to perform steps of a method for sending a Paging Early Indication (PEI).

In some examples, a user equipment (UE) includes: a processor; and a memory for storing instructions executable by the processor; in which the processor is configured to execute the executable instructions in the memory to perform steps of a method for receiving a Paging Early Indication (PEI).

In some examples, a non-transitory computer-readable storage medium is provided. The non-transitory computer-readable storage medium has executable instructions stored thereon. When the executable instructions are executed by a processor, steps of a method for sending a Paging Early Indication (PEI) or steps of a method for receiving a Paging Early Indication (PEI) are performed.

The technical solutions according to embodiments of the disclosure include the following beneficial effects. The target PO is determined based on the offset duration that has already been configured, and the PEI corresponding to the UE group are sent on the time-frequency resource of the target PO, thereby providing a solution for determining the target PO.

1. A method for sending a paging early indication (PEI), performed by a network side device, comprising:
determining a target paging occasion based on a first target moment, wherein the first target moment is before a starting moment of a paging occasion of a user equipment group and is separated from the starting moment by an offset duration; and
sending, on a time-frequency resource of the target paging occasion, a Paging Early Indication (PEI) corresponding to the user equipment group.

2. The method of claim 1, wherein determining the target paging occasion based on the first target moment comprises at least one of:
determining a paging occasion before the first target moment and closest to the first target moment as the target paging occasion;
or,
determining a paging occasion after the first target moment and closest to the first target moment as the target paging occasion.

3. The method of claim 1, wherein determining the target paging occasion based on the first target moment comprises:
determining a target paging frame based on the first target moment; and
determining one paging occasion within the target paging frame as the target paging occasion.

4. The method of claim 3, wherein the target paging frame comprises at least one of:
a target paging frame whose starting moment is before the first target moment and closest to the first target moment;
a target paging frame whose ending moment is before the first target moment and closest to the first target moment;
a target paging frame whose starting moment is after the first target moment and closest to the first target moment; or
a target paging frame whose ending moment is after the first target moment and closest to the first target moment.

5. The method of claim 3, wherein determining one paging occasion within the target paging frame as the target paging occasion comprises:
determining a set paging occasion within the target paging frame as the target paging occasion.

6. The method of claim 3, wherein determining one paging occasion within the target paging frame as the target paging occasion comprises:
determining one paging occasion within the target paging frame as the target paging occasion, wherein an index of the paging occasion within the target paging frame is identical to an index of the paging occasion of the user equipment group.

7. The method of claim 1, wherein sending, on the time-frequency resource of the target paging occasion, the PEI corresponding to the user equipment group comprises:
sending paging downlink control information on the time-frequency resource of the target paging occasion, wherein the paging downlink control information comprises a preset field, and the preset field contains the PEI corresponding to the user equipment group.

8. The method of claim 1, wherein sending, on the time-frequency resource of the target paging occasion, the PEI corresponding to the user equipment group comprises:
sending a paging downlink control information on the time-frequency resource of the target paging occasion, wherein the paging downlink control information comprises N preset bits, and each of the N preset bits contains a PEI corresponding to a subgroup of the user equipment group, wherein N represents the number of subgroups in the user equipment group.

9. A method for receiving a paging early indication (PEI), performed by a user equipment, comprising:
determining a target paging occasion based on a second target moment, wherein the second target moment is before a starting moment of a paging occasion of the user equipment and is separated from the starting moment by an offset duration; and
receiving, on a time-frequency resource of the target paging occasion, a Paging Early Indication (PEI) corresponding to the user equipment.

10. The method of claim 9, wherein determining the target paging occasion based on the second target moment comprises at least one of:
determining a paging occasion before the second target moment and closest to the second target moment as the target paging occasion;
or,
determining a paging occasion after the second target moment and closest to the second target moment as the target paging occasion.

11. The method of claim 9, wherein determining the target paging occasion based on the second target moment comprises:
determining a target paging frame based on the second target moment; and
determining one paging occasion within the target paging frame as the target paging occasion.

12. The method of claim 11, wherein the target paging frame comprises at least one of:
a target paging frame whose starting moment is before the second target moment and closest to the second target moment;
a target paging frame whose ending moment is before the second target moment and closest to the second target moment;
a target paging frame whose starting moment is after the second target moment and closest to the second target moment; and
a target paging frame whose ending moment is after the second target moment and closest to the second target moment.

13. The method of claim 11 or 12, wherein determining one paging occasion within the target paging frame as the target paging occasion comprises:
determining a set paging occasion within the target paging frame as the target paging occasion.

14. The method of claim 11 or 12, wherein determining the paging occasion within the target paging frame as the target paging occasion comprises:
determining one paging occasion within the target paging frame as the target paging occasion, wherein an index of the paging occasion within the target paging frame is identical to an index of the paging occasion of the user equipment.

15. The method of claim 9, wherein receiving, on the time-frequency resource of the target paging occasion, the PEI corresponding to the user equipment comprises:
receiving a paging downlink control information on the time-frequency resource of the target paging occasion, wherein the paging downlink control information comprises a preset field, and the preset field contains the PEI corresponding to the user equipment.

16. The method of claim 9, wherein receiving, on the time-frequency resource of the target paging occasion, the PEI corresponding to the user equipment comprises:
receiving a paging downlink control information on the time-frequency resource of the target paging occasion, wherein the paging downlink control information comprises preset bits corresponding to the user equipment, and the preset bits contain the PEI corresponding to the user equipment.

17-18. (canceled)

19. A base station device, comprising:
a processor; and
a memory for storing instructions executable by the processor; wherein
when the executable instructions in the memory are executed by the processor, the base station device is caused to:
determine a target paging occasion based on a first target moment, wherein the first target moment is before a starting moment of a paging occasion of a user equipment group and is separated from the starting moment by an offset duration; and
send, on a time-frequency resource of the target paging occasion, a Paging Early Indication (PEI) corresponding to the user equipment group.

20. A user equipment, comprising:
a processor; and
a memory for storing instructions executable by the processor; wherein
when the executable instructions in the memory are executed by the processor, the user equipment is caused to perform the method of claim 9.

21. A non-transitory computer-readable storage medium, having executable instructions stored thereon, wherein when the executable instructions are executed by a processor, the method of claim 1 is performed.

22. A non-transitory computer-readable storage medium, having executable instructions stored thereon, wherein when the executable instructions are executed by a processor, the method of claim 9 is performed.
